(19) United States
(12) Patent Application Publication
(10) Pub. No.: US 2025/0386163 A1
(43) Pub. Date: Dec. 18, 2025

(54) LOCALIZATION VERIFICATION BASED ON MOBILE DEVICE POSSESSION

(71) Applicant: MICROSOFT TECHNOLOGY LICENSING, LLC, Redmond, WA (US)

(72) Inventor: Landon Prentice COX, Seattle, WA (US)

(21) Appl. No.: 18/744,082

(22) Filed: Jun. 14, 2024

(51) Int. Cl. H04W 4/021

(52) U.S. Cl. CPC H04W 4/021

(57) ABSTRACT

A service provider improves the manner in which a location of a device being used by a user to access a service is determined. The service provider receives a request to access a service hosted in a cloud platform. The request identifies a user account and the request is associated with an Internet Protocol (IP) address. The service provider associates the request with information, such as a phone number, registered for the user account. The service provider sends a query to a mobile network operator asking for a location of a mobile device identified by the information. The service provider receives, from the mobile network operator, the location of the mobile device and then implements an action based on the location of the mobile device identified by the information rather than another location determined based on the IP address.

### BACKGROUND

Service providers often host services (e.g., applications or “apps” that provide content, features, functions, processes) in a datacenter that includes various processing resources, networking resources, and storage resources. The datacenter may be configured as part of a cloud platform such as MICROSOFT AZURE, AMAZON WEB SERVICES, GOOGLE CLOUD, etc. Accordingly, datacenters are useable to provide the hosted services to users at remote locations via network connections established in accordance with the Internet Protocol (IP). Some of these services are dependent on a location of a user, or more specifically, the location of a device being used by the user to access the services. The location of the device is typically determined using IP-based localization techniques, e.g., based on the mapping of an IP address to a geographic region and/or to an Internet Service Provider (ISP) that operates in a geographic region. It is with respect to these considerations and others that the disclosure made herein is presented.

### SUMMARY

The system described herein improves the manner in which a location of a device being used by a user to access a service being hosted in a cloud platform (e.g., a datacenter) is determined. As mentioned above, the location is typically determined using Internet Protocol-based (IP-based) localization techniques. Unfortunately, IP-based localization techniques can present some problems for service providers. First, IP-based localization techniques are not always able to accurately pinpoint the location of the device. For instance, IP-based localization techniques may determine that an estimated location of a device is many kilometers away from the actual real-world location of the device.

Second, IP-based localization techniques are susceptible to deceptive, and at times, fraudulent activity. That is, a user can make it seem that a device is at a location that is different than the actual real-world location of the device. In one example, a user can manually configure an Internet Protocol (IP) address so that the device communicates a “deceptive” IP address when connecting to the cloud platform. The deceptive IP address maps to a geographic region that does not include the actual real-world location of the device. Alternatively, a user can use a virtual private network (VPN) to alter the IP address that is communicated when connecting to the cloud platform. That is, the deceptive IP address can be associated with a different device that maps to a geographic region that does not include the actual real-world location of the device requesting access to a service.

To address these problems associated with IP-based localization techniques, the system described herein takes advantage of the fact that most users have mobile devices (e.g., smartphones, phones) that are connected to, or connectable to, a mobile network. A mobile network can include cellular and/or satellite networks (e.g., 6G networks, 5G networks, LTE networks, and so forth). Stated alternatively, a user possesses a mobile device such that the user and the mobile device are co-located as the user typically keeps the mobile device within their vicinity (e.g., within a pocket or a purse, within the same structure or area such as a home or work office). The system uses the mobile device and the mobile network to accurately determine the location of a user that requests to access a service being hosted in a cloud platform via an IP-based network connection.

The mobile network is different than the network(s) used to establish the IP-based network connection. Moreover, operators of mobile networks (e.g., VERIZON, AT&T, and T-MOBILE) implement localization techniques that are more accurate when compared to IP-based localization techniques. For instance, localization techniques implemented via mobile networks are based on the use of one or more cell towers (e.g., a strength of a signal detected at one cell tower, cell tower triangulation) – which can estimate the location of a mobile device within a neighborhood or even meters and not the many kilometers at which the IP-based localization techniques estimates the location of the mobile device. Other localization techniques implemented via mobile networks are also contemplated in the context of this disclosure. Additionally, a user cannot make it seem that a mobile device is at a location that is different than the actual real-world location of the device when the localization techniques are implemented via mobile networks. Thus, the deception that can be implemented via IP-based localization techniques can be discovered using the localization techniques implemented via mobile networks.

As further described below, a service provider hosting a service in a cloud platform stores a user account for a user. The user account includes, or registers, information (e.g., a phone number) that identifies a user’s mobile device (e.g., smartphone). Examples of a service include a streaming service configured to stream content (e.g., movies, programs, short videos, music videos), a gaming service configured to enable a group of users to play an online game, a videoconference service configured to enable a group of users to conduct meetings and/or collaborate for personal or business purposes, a transaction service configured to process a transaction. Other types of services are also contemplated in the context of this disclosure.

The user requests access to the service via a device that establishes an IP-based network connection. The device may not be the user’s mobile device. Accordingly, the access request identifies the user account and the access request is associated with an IP address. The service provider receives the access request and associates the access request with the information (e.g., a phone number) registered for or in the user account and that identifies the mobile device. The service provider uses the information to identify a mobile network operator to which the mobile device and the user are subscribed. The service provider then sends a query to the mobile network operator. The query asks for a location of a mobile device. As mentioned above, the query is sent based on the high quality assumption, by the service provider, that the user typically possesses their mobile device identified by the information such as a phone number.

Based on the query, the mobile network operator determines the location of the mobile device using mobile network-based localization techniques such as cell tower triangulation techniques. The mobile network operator returns the location of the mobile device to the service provider. Accordingly, the service provider receives the location of the mobile device from the mobile network operator and implements an action based on the location of the mobile device, as determined by the mobile network operator, rather than a location determined based on the IP address associated with the initial access request. Stated alternatively, via the system described herein, a service provider is able to infer an accurate user location based on mobile network-based localization techniques rather than IP-based localization techniques.

In one example, the action implemented by the service provider based on the location of the mobile device comprises selecting an edge server, amongst multiple available edge servers, from which content can be provided. The edge server selection is made based on an edge server location that is closest to the location of the mobile device identified by the information. Service providers often use edge servers to provide efficient delivery of content (e.g., streaming content, gaming content, videoconference content). The use of an edge server reduces the latency associated with the delivery of the content. That is, the user experience is improved by executing at least part of the service at an edge server that is physically located closer to the user’s device compared to a server configured in a datacenter.

In another example, the action implemented by the service provider based on the location of the mobile device comprises preventing the service from completing a location-based operation that is associated with a geographic restriction (e.g., the user and/or the user device must be within a defined geofence such as a country, a state, a county, a city). More specifically, the service provider determines that the location of the mobile device, as determined by the mobile network operator, violates the geographic restriction. This prevention can be useful when the location of the device that sent the access request, as determined based on a deceptive IP address, complies with the geographic restriction. Stated alternatively, the location of the mobile device determined by the mobile network operator is inconsistent with the location of the device that sent the access request, as determined based on a deceptive IP address.

In one example, the service implements some form of transaction processing. To illustrate, a user may configure a deceptive IP address to illegally place a wager with a gambling site when the user is not actually located in a state that legally allows the placement of online wagers. Or, a user may configure a deceptive IP address to illegally purchase an item (e.g., a ticket to an event such as a concert or a soccer game) from a retail site when the user is not actually located in a geographic region to which purchases of the item are limited. Using the techniques described herein, the service provider can prevent the transaction from being completed.

In various examples, the mobile device (e.g., a smartphone) is different than the device that sent the access request (e.g., a smart television, a desktop computer, a laptop computer, a gaming console, a head-mounted device). However, the mobile device and the device that sent the access request can also be the same device (e.g., a smartphone) configured to use both mobile networks and IP-based networks.

The user and device location verification based on mobile device possession, as described herein, is implemented with consent from the user. In one example, the user consent is obtained per instance of service access. After the service provider sends the location query to the mobile network operator, the service provider receives, from the mobile network operator, a uniform resource locator configured to obtain the user consent enabling the location of the mobile device to be determined by the mobile network operator. The service provider then provides the uniform resource locator to the device from which the access request is received and receives, by way of the uniform resource locator, the user consent. The service provider can then provide an indication of the user consent to the mobile network operator.

In another example, the service provider requests and obtains the user consent in association with the terms of use for the service. That is, the user may be required to agree to the terms of use, and to provide the user consent, when subscribing to the service and/or setting up the user account. This additional type of user consent serves as a preauthorization and can be applied to subsequent instances of service access. Accordingly, the service provider can provide an indication of the user consent, as agreed upon via the terms of use, to the mobile network operator.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1 illustrates an example environment in which a system used by a service provider can improve the manner in which a location of a device being used by a user to access a service is determined.

FIG. 2 illustrates an example of how the location of the device being used to access a service can enable a more accurate selection of the closest edge server, to reduce latency related to content delivery and consumption.

FIG. 3 illustrates an example of how the location of the device being used to access a service can prevent location-based operations that violate geographic restrictions from being performed.

FIG. 4 illustrates an example of how a service provider obtains user consent for determining a location of a device being used by a user to access a service.

FIG. 5 is a flowchart depicting an example procedure for improving the manner in which a location of a device being used by a user to access a service is determined.

FIG. 6 is an example computing system in accordance with the present disclosure.

### DETAILED DESCRIPTION

The system disclosed herein is used by a service provider to improve the manner in which a location of a device being used by a user to access a service is determined. The service provider receives a request to access a service hosted in a cloud platform. The request identifies a user account and the request is associated with an Internet Protocol (IP) address. The service provider associates the request with information registered for or in the user account. The information (e.g., a phone number) identifies a mobile device. The service provider sends a query to a mobile network operator asking for a location of the mobile device identified by the information. The service provider receives, from the mobile network operator, the location of the mobile device and then implements an action based on the location of the mobile device identified by the information rather than another location determined based on the IP address.

The location of a device can be determined using Internet Protocol-based (IP-based) localization techniques. Unfortunately, IP-based localization techniques can present some problems for service providers. First, IP-based localization techniques are not always able to accurately pinpoint the location of the device. For instance, IP-based localization techniques may determine that an estimated location of a device is many kilometers away from the actual real-world location of the device.

Second, IP-based localization techniques are susceptible to deceptive, and at times, fraudulent activity. That is, a user can make it seem that a device is at a location that is different than the actual real-world location of the device. In one example, a user can manually configure an IP address so that the device communicates a “deceptive” IP address when connecting to the cloud platform. The deceptive IP address maps to a geographic region that does not include the actual real-world location of the device. Alternatively, a user can use a virtual private network (VPN) to alter the IP address that is communicated when connecting to a cloud platform (e.g., a datacenter). That is, the deceptive IP address can be associated with a different device that maps to a geographic region that does not include the actual real-world location of the device requesting access to a service.

To address these problems associated with IP-based localization techniques, the system described herein takes advantage of the fact that most users have mobile devices (e.g., smartphones) that are connected to, or connectable to, a mobile network. A mobile network can include cellular and/or satellite networks (e.g., 6G networks, 5G networks, LTE networks, and so forth). Stated alternatively, a user possesses a mobile device such that the user and the mobile device are co-located as the user typically keeps the mobile device within their vicinity (e.g., within a pocket or a purse, within the same structure or area such as a home or work office). The system uses the mobile device and the mobile network to accurately determine the location of a user that requests to access a service being hosted in a cloud platform via an IP-based network connection.

The mobile network is different than the network(s) used to establish the IP-based network connection. Moreover, operators of mobile networks (e.g., VERIZON, AT&T, and T-MOBILE) implement localization techniques that are more accurate when compared to IP-based localization techniques. For instance, localization techniques implemented via mobile networks are based on the use one or more cell towers (e.g., a strength of a signal detected at one cell tower, cell tower triangulation) – which can estimate the location of a mobile device within a neighborhood or even meters and not the many kilometers at which the IP-based localization techniques estimates the location of the mobile device. Other localization techniques implemented via mobile networks are also contemplated in the context of this disclosure. Additionally, a user cannot make it seem that a mobile device is at a location that is different than the actual real-world location of the device when the localization techniques are implemented via mobile networks. Thus, the deception that can be implemented via IP-based localization techniques can be discovered using the localization techniques implemented via mobile networks.

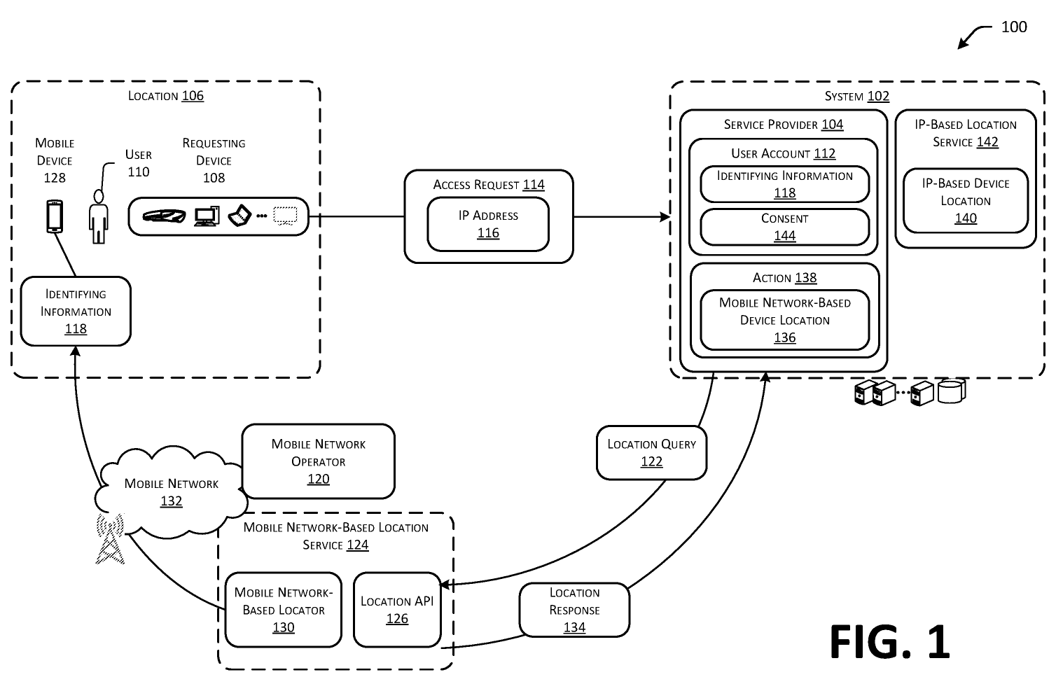

FIG. 1 illustrates an example environment 100 in which a system 102 used by a service provider 104 can improve the manner in which a location 106 of a device 108 being used by a user 110 to access a service is determined. The system 102 is implemented within a cloud platform. The service provider 104 hosts a service in the cloud platform and stores a user account 112 for the user 110. Examples of a service include a streaming service configured to stream content (e.g., movies, programs, short videos, music videos), a gaming service configured to enable a group of users to play an online game, a videoconference service configured to enable a group of users to conduct meetings and/or collaborate for personal or business purposes, a transaction service configured to process a transaction, etc. Other types of services are also contemplated in the context of this disclosure.

Via the device 108, the user 110 requests access (i.e., issues an access request 114) to the service via an IP-based network connection. Accordingly, device 108 is referred to as a “requesting” device 108. The access request 114 identifies the user account 112 and the access request 114 is associated with an IP address 116. The service provider 104 receives the access request 114 and associates the access request 114 with information 118 registered for or in the user account 112. In one example, the information 118 is a phone number.

The service provider 104 uses the information 118 to identify a mobile network operator 120 to which the user 110 is subscribed. The service provider 104 then sends a location query 122 to a mobile network-based location service 124 of the mobile network operator 120. In one example, the location query 122 is sent to a location application programming interface (API) 126 configured in accordance with the mobile network-based location service 124.

The location query 122 asks for the location 106 of a mobile device 128 (e.g., a phone, a smartphone) identified by the information 118. As mentioned above, the location query 122 is sent based on the high quality assumption, by the service provider 104, that the user 110 typically possesses their own mobile device 128 identified by the information 118. Based on the location query 122, the mobile network-based location service 124 of the mobile network operator 120 implements a mobile network-based locator 130 to determine, or estimate, the location 106 of the mobile device 128 using techniques implemented via a mobile network 132. For example, mobile network-based localization techniques include the use of one or more cell towers (e.g., cell tower triangulation). The mobile network-based location service 124 of the mobile network operator 120 returns the estimated location of the mobile device 128 to the service provider 104 in a location response 134.

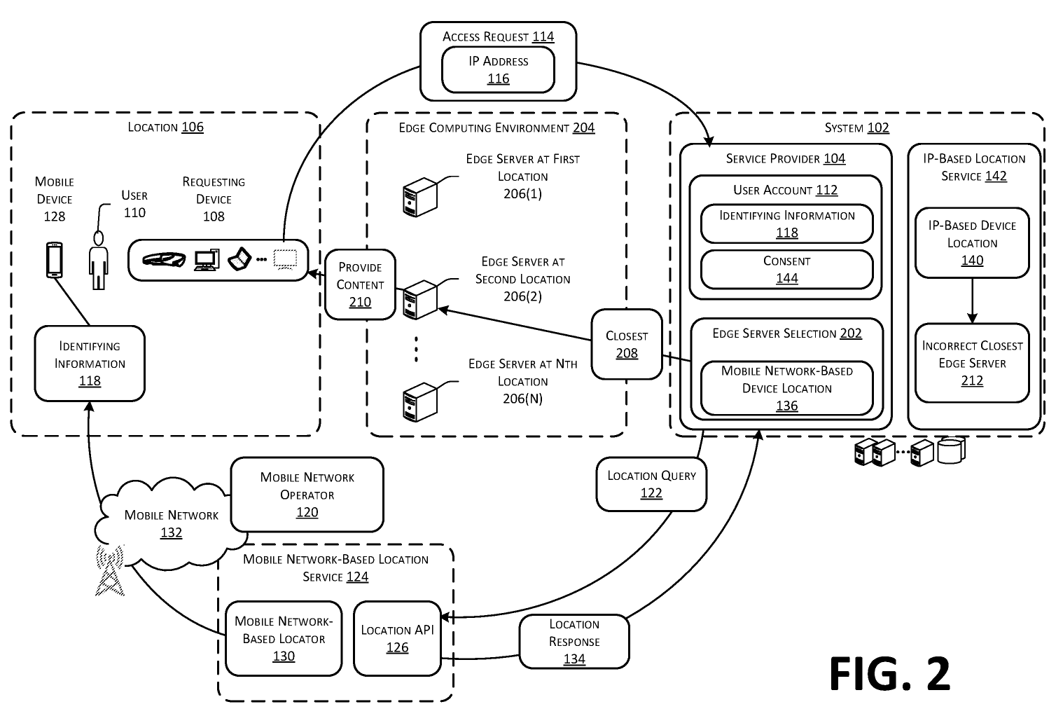

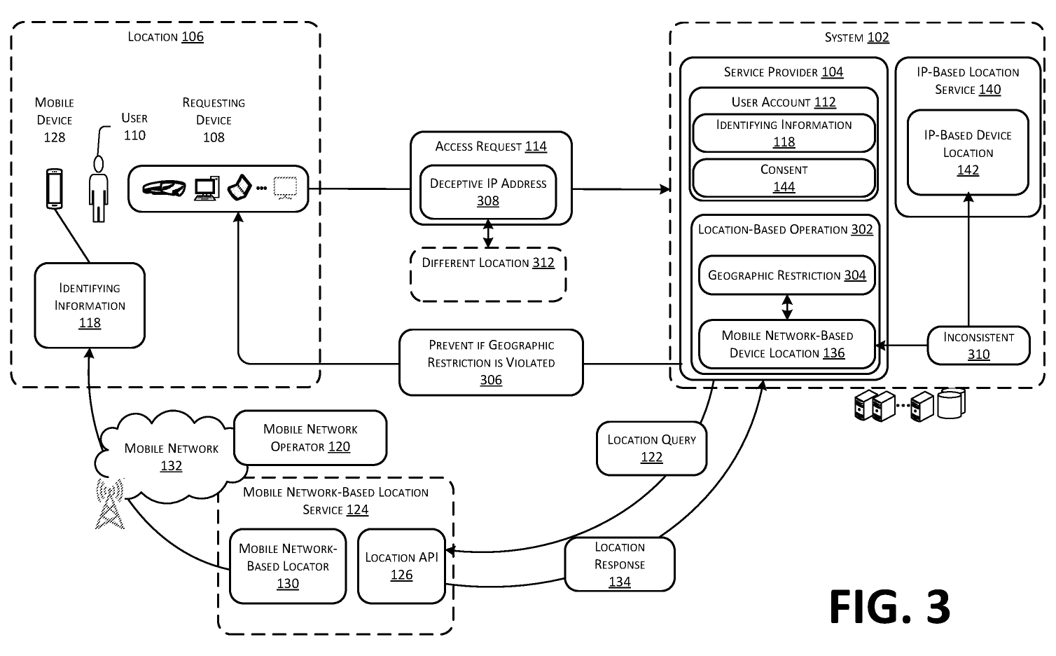

Accordingly, the service provider 104 receives the location response 134 and registers a mobile network-based device location 136 (that more accurately reflects the actual real-world location 106) associated with the requesting device 108. Moreover, the service provider 104 implements an action 138 based on the mobile network-based device location 136, examples of which are described below with respect to FIGS. 2 and 3.

The service provider 104 uses the mobile network-based device location 136 instead of an IP-based device location 140, determined by an IP-based location service 142 based on the IP address 116 associated with the initial access request 114, because the IP-based device location 140 is not always accurate. For example, the estimated location 140 can be many kilometers away from the actual real-world location 106 of the requesting device 108. Moreover, the IP address 116 can be a deceptive IP address that maps to a geographic region that does not include the actual real-world location 106 of the requesting device 108.

Via the likely user possession of the mobile device 128, the system 102 is able to use the information 118 stored in the user account 112, the mobile device 128 identified by the information 118, and the mobile network 132 to accurately determine the location 106 of a user 110 that requests to access a service via an IP-based network connection. Stated alternatively, the service provider 104 is able to infer an accurate user location based on mobile network-based localization techniques rather than IP-based localization techniques.

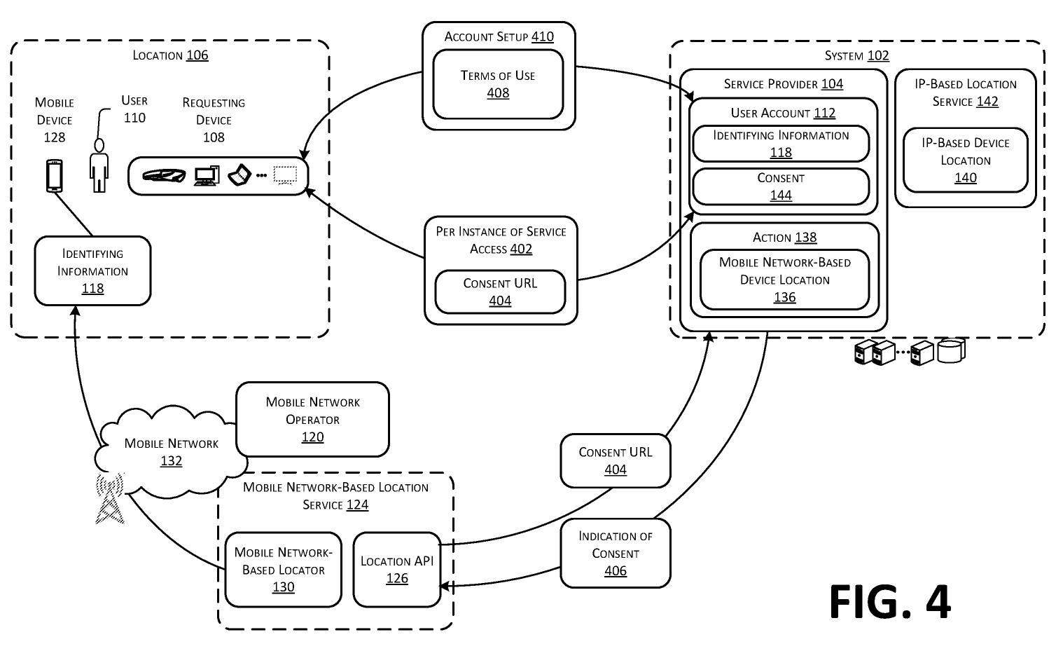

In various examples, the mobile device 128 (e.g., a smartphone) is different than the requesting device 108 that sends the access request 114 (e.g., a smart television, a desktop computer, a laptop computer, a gaming console, a head-mounted device). However, the mobile device 128 and the requesting device 108 that send the access request 114 can also be the same device (e.g., a smartphone) configured to use both mobile networks and IP-based networks. Additionally, the user and device location verification based on mobile device possession, as described herein, is implemented with consent 144 from the user 110, examples of which are described below with respect to FIG. 4.

FIG. 2 illustrates an example of how the mobile network-based device location 136 can enable a more accurate selection of the closest edge server. A more accurate selection of the closest edge server can have a significant effect on the latency related to content delivery and consumption. Accordingly, the action 138 implemented by the service provider 104 in FIG. 1 is referred to as edge server selection 202 in FIG. 2. Service providers often use edge servers to provide efficient delivery of content (e.g., streaming content, gaming content, videoconference content). The use of an edge server reduces the latency associated with the delivery of the content. That is, the user experience is improved by executing at least part of the service at an edge server that is physically located closer to the user’s device (e.g., the requesting device 108) compared to a server configured in a datacenter.

Accordingly, FIG. 2 illustrates an edge computing environment 204 with an N number of edge servers 206(1-N) geographically dispersed across a continent or a country. The service provider 104 knows the location of each of the edge servers 206(1-N), and thus, the service provider 104 can use the mobile network-based device location 136 to select the closest 208 edge server 206(2), amongst the edge servers 206(1-N), based on calculated distances between the mobile network-based device location 136 and the known locations of the edge servers 206(1-N). Thus, the action 138 in FIG. 1 selects the edge server 206(2) to provide content 210 (e.g., streaming content, gaming content, videoconference content) in a manner that reduces latency.

To illustrate a scenario in which the edge server selection 202 is useful, consider that the user 110 may travel to stay at a rented vacation home at location 106. In this example, the location 106 is between the location of edge server 206(1) and the location of edge server 206(2). The user 110 may take their own game console to the rented vacation home to connect to a gaming service via a local area network (e.g., a Wi-Fi connection). Alternatively, the user 110 may log into the user account 112 via a smart television to stream a movie via a streaming service. The smart television may be provided for use by an owner of the vacation home and may be connected to the local area network. Consequently, the requesting device 108 in this example is the game console or the smart television.

Now, the IP-based device location 140 may reflect that the requesting device 108 is closer to the edge server 206(1) rather than to the actual closest edge server 206(2). Thus, the less accurate IP-based location service 142 may be used to incorrectly identify the closest edge server 212 (e.g., edge server 206(1)) for content delivery – which would cause an increase in latency compared to the selection and use of edge server 206(2).

FIG. 3 illustrates an example of how the mobile network-based device location 136 can prevent a location-based operation 302 that violates a geographic restriction 304 from being performed. The geographic restriction 304 may require the user 110 to be located in a particular geographic region associated with a geofence (e.g., a country, a state, a county, a city) in order for the service provider 104 to perform the location-based operation 302 for the user 110. Accordingly, if the service provider 104 determines that the mobile network-based device location 136 violates the geographic restriction 304, the location-based operation is prevented 36 from being completed.

This prevention 306 can be useful when the IP-based device location 142 is determined based on a deceptive IP address 308, and thus, the mobile network-based device location 136 is inconsistent 310 with the IP-based device location 142. In one example, the service implements some form of transaction processing. In this example, the user 110 may configure the deceptive IP address 308 to reflect a location 312 that is different than location 106. The different location 312 is selected to comply with the geographic restriction 304. Consequently, the user 110 is able to illegally place a wager with a gambling site when the user is not actually located in a state that legally allows the placement of online wagers. Or, the user 110 is able to illegally purchase an item (e.g., a ticket to an event such as a concert or a soccer game) from a retail site when the user is not actually located in a geographic region to which purchases of the item are limited. Using the techniques described herein, the service provider can prevent the transaction from being completed.

FIG. 4 illustrates an example of how a service provider obtains the user consent 144 for determining a location of a device being used by a user to access a service. In one example, the user consent 144 is obtained per instance of service access 402 (e.g., each time the user requests access to the service with an access request 114). In this example, after the service provider 104 sends the location query 122 to the mobile network-based location service 124 of the mobile network operator 120, the service provider 104 receives a uniform resource locator 404 configured to obtain the user consent 144 enabling the mobile network-based device location 136 to be determined by the mobile network operator 120. The service provider 104 then provides the uniform resource locator 404 to the requesting device 108. The user 110 then provides the user consent 144 by way of the content displayed via the uniform resource locator 404 and the service provider 104 provides an indication 406 of the user consent to the mobile network-based location service 124 of the mobile network operator 120.

In another example, the service provider 104 requests and obtains the user consent 144 in association with the terms of use 408 for the service. That is, the user 110 may be required to agree to the terms of use 408, and to provide the user consent 144, when subscribing to the service and/or setting up the user account 410. This additional type of user consent serves as a preauthorization and can be applied to subsequent instances of service access. Accordingly, the service provider 104 can provide the indication 406 of the user consent, as agreed upon via the terms of use 408, to the mobile network-based location service 124 of the mobile network operator 120.

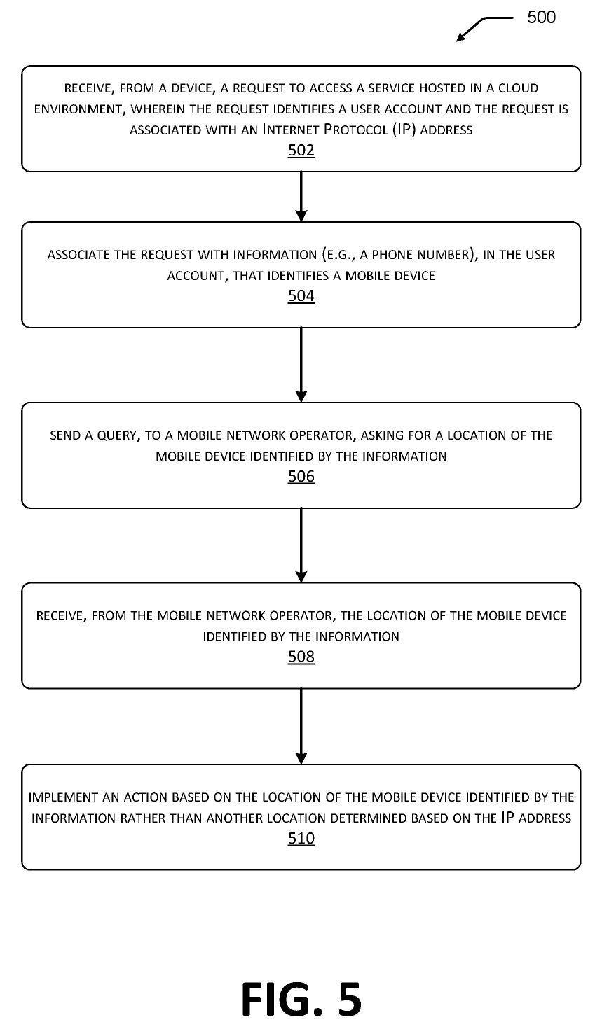

Turning now to FIG. 5, an example operational procedure for improving the manner in which a location of a device being used by a user to access a service is determined is illustrated. The operational procedure can be implemented in accordance with the discussion of FIGS. 1-4.

It should be understood by those of ordinary skill in the art that the operations disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated operational procedure can end at any time and need not be performed in its entirety. Some or all of the operations can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. The implementation is a matter of choice dependent on the performance and other requirements of the computing system. Accordingly, the logical operations may be implemented in software, in firmware, in special purpose digital logic, and any combination thereof.

The flowchart 500 in FIG. 5 starts at operation 502 where a service provider receives a request to access a service hosted in a cloud platform. The request identifies a user account and the request is associated with an Internet Protocol (IP) address.

At operation 504, the service provider associates the request with information, such as a phone number, in the user account. The information identifies a mobile device.

At operation 508, the service provider sends a query, to a mobile network operator, asking for a location of the mobile device identified by the information.

At operation 508, the service provider receives, from the mobile network operator, the location of the mobile device identified by the information.

At operation 510, the service provider implements an action based on the location of the mobile device identified by the information rather than another location determined based on the IP address. In one example, the action is related to the selection of a closest edge server. In another example, the action is related to the prevention of completing a location-based operation for a user.

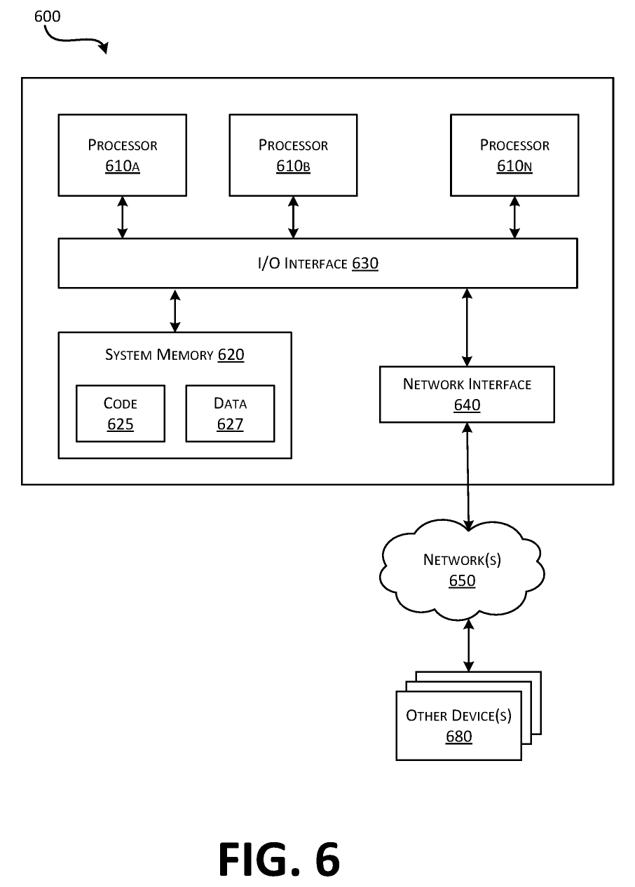

FIG. 6 illustrates a general-purpose computing device 600. In the illustrated embodiment, computing device 600 includes one or more processors 610a, 610b, and/or 610n (which may be referred herein singularly as "a processor 610" or in the plural as "the processors 610") coupled to a system memory 620 via an input/output (I/O) interface 630. Computing device 600 further includes a network interface 640 coupled to I/O interface 630.

In various embodiments, computing device 600 may be a uniprocessor system including one processor 610 or a multiprocessor system including several processors 610 (e.g., two, four, eight, or another suitable number). Processors 610 may be any suitable processors capable of executing instructions. For example, in various embodiments, processors 610 may be general-purpose or embedded processors implementing any of a variety of instruction set architectures (ISAs), such as the x88, PowerPC, SPARC, or MIPS ISAs, or any other suitable ISA. In multiprocessor systems, each of processors 610 may commonly, but not necessarily, implement the same ISA.

System memory 620 may be configured to store instructions and data accessible by processor(s) 610. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques and data described above, are shown stored within system memory 620 as code 625 and data 627.

In one embodiment, I/O interface 630 may be configured to coordinate I/O traffic between the processor 610, system memory 620, and any peripheral devices in the device, including network interface 640 or other peripheral interfaces. In some embodiments, I/O interface 630 may perform any necessary protocol, timing, or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components. Also, in some embodiments some or all of the functionality of I/O interface 630, such as an interface to system memory 620, may be incorporated directly into processor 610.

Network interface 640 may be configured to allow data to be exchanged between computing device 600 and other device or devices 680 attached to a network or network(s) 680, such as other computer systems or devices as illustrated in FIGS. 1 through 4, for example. In various embodiments, network interface 640 may support communication via any suitable wired or wireless general data networks. Additionally, network interface 640 may support communication via telecommunications/telephony networks such as analog voice networks or digital fiber communications networks, via storage area networks such as Fibre Channel SANs or via any other suitable type of network and/or protocol.

In some embodiments, system memory 620 may be one embodiment of a computer-accessible medium configured to store program instructions and data as described above for FIGS. 1-5 for implementing embodiments of the corresponding method and apparatus. However, in other embodiments, program instructions and/or data may be received, sent or stored upon different types of computer-accessible media. A computer-accessible medium may include non-transitory storage media or memory media, such as magnetic or optical media, e.g., disk or DVD/CD coupled to computing device 600 via I/O interface 630. A non-transitory computer-accessible storage medium may also include any volatile or non-volatile media, such as RAM (e.g. SDRAM, DDR SDRAM, RDRAM, SRAM, etc.), ROM, etc., that may be included in some embodiments of computing device 600 as system memory 620 or another type of memory. Further, a computer-accessible medium may include transmission media or signals such as electrical, electromagnetic or digital signals, conveyed via a communication medium such as a network and/or a wireless link, such as may be implemented via network interface 640. Portions or all of multiple computing devices, such as those illustrated in FIG. 6, may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term "computing device," as used herein, refers to at least all these types of devices and is not limited to these types of devices.

Various storage devices and their associated computer-readable media provide non-volatile storage for the computing devices described herein. Computer-readable media as discussed herein may refer to a mass storage device, such as a solid-state drive, a hard disk or CD-ROM drive. However, it should be appreciated by those skilled in the art that computer-readable media can be any available computer storage media that can be accessed by a computing device.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing devices discussed herein. For purposes of the claims, the phrase “computer storage medium,” “computer-readable storage medium” and variations thereof, does not include waves, signals, and/or other transitory and/or intangible communication media, per se.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the disclosed computing devices in order to store and execute the software components and/or functionality presented herein. It is also contemplated that the disclosed computing devices may not include all of the illustrated components shown in FIG. 6, may include other components that are not explicitly shown in FIG. 6, or may utilize an architecture completely different than that shown in FIG. 6.

The disclosure presented herein also encompasses the subject matter set forth in the following clauses.

Example Clause A, a method for verifying a location of a device via use of a mobile network, the method comprising: receiving, from the device, a request to access a service hosted via a cloud platform, wherein the request identifies a user account and the request is associated with an Internet Protocol (IP) address; associating the request with information, registered for or in the user account, that identifies a mobile device; sending a query, to a mobile network operator, asking for a location of the mobile device identified by the information; receiving, from the mobile network operator, the location of the mobile device identified by the information; and implementing an action based on the location of the mobile device identified by the information rather than another location determined based on the IP address, wherein: the action comprises selecting an edge server, amongst multiple available edge servers, from which content associated with the service can be provided; and the selection is made based on an edge server location that is closest to the location of the mobile device identified by the information.

Example Clause B, the method of Example Clause A, wherein: the information that identifies the mobile device comprises a phone number; and the phone number and the mobile device are subscribed to a mobile network operated by the mobile network operator.

Example Clause C, the method of Example Clause A or Example Clause B, wherein the content includes at least one of streaming content, gaming content, or videoconference content.

Example Clause D, the method of any one of Example Clauses A through C, further comprising: receiving, from the mobile network operator, a uniform resource locator configured to obtain user consent for determining the location of the mobile device identified by the information; providing the uniform resource locator to the device from which the request is received; receiving, by way of the uniform resource locator, the user consent; and providing an indication of the user consent to the mobile network operator.

Example Clause E, the method of any one of Example Clauses A through C, further comprising: requesting user consent for determining the location of the mobile device identified by the information in association with terms of use for the service during a setup of the user account; receiving, by way of the terms of use, the user consent; and providing an indication of the user consent to the mobile network operator.

Example Clause F, the method of any one of Example Clauses A through E, wherein the mobile device and the device from which the request is received are different devices.

Example Clause G, the method of any one of Example Clauses A through E, wherein the mobile device and the device from which the request is received are a same device.

Example Clause H, the method of any one of Example Clauses A through G, wherein the mobile network operator uses cell tower triangulation to determine the location of the mobile device.

Example Clause I, a method for verifying a location of a device via use of a mobile network, the method comprising: receiving, from the device, a request to access a service hosted via a cloud platform, wherein the request identifies a user account and the request is associated with an Internet Protocol (IP) address; associating the request with information, registered for or in the user account, that identifies a mobile device; sending a query, to a mobile network operator, asking for a location of the mobile device identified by the information; receiving, from the mobile network operator, the location of the mobile device identified by the information; and implementing an action based on the location of the mobile device identified by the information rather than another location determined based on the IP address, wherein the action comprises preventing the service from completing a location-based operation based at least in part on the location of the mobile device violating a geographic restriction associated with the location-based operation.

Example Clause J, the method of Example Clause I, wherein: the location-based operation comprises a transaction; and the other location determined based on the IP address complies with the geographic restriction.

Example Clause K, the method of Example Clause I or Example Clause J, wherein: the information that identifies the mobile device comprises a phone number; and the phone number and the mobile device are subscribed to a mobile network operated by the mobile network operator.

Example Clause L, the method of any one of Example Clauses I through K, further comprising: receiving, from the mobile network operator, a uniform resource locator configured to obtain user consent for determining the location of the mobile device identified by the information; providing the uniform resource locator to the device from which the request is received; receiving, by way of the uniform resource locator, the user consent; and providing an indication of the user consent to the mobile network operator.

Example Clause M, the method of any one of Example Clauses I through K, further comprising: requesting user consent for determining the location of the mobile device identified by the information in association with terms of use for the service during a setup of the user account; receiving, by way of the terms of use, the user consent; and providing an indication of the user consent to the mobile network operator.

Example Clause N, a system comprising: one or more processers; and computer storage media storing instructions that, when executed by the one or more processors, cause the system to perform operations comprising: receiving, from a device, a request to access a service hosted via a cloud platform, wherein the request identifies a user account and the request is associated with an Internet Protocol (IP) address; associating the request with information, registered for or in the user account, that identifies a mobile device; sending a query, to a mobile network operator, asking for a location of the mobile device identified by the information; receiving, from the mobile network operator, the location of the mobile device identified by the information; and implementing an action based on the location of the mobile device identified by the information rather than another location determined based on the IP address.

Example Clause O, the system of Example Clause N, wherein: the action comprises selecting an edge server, amongst multiple available edge servers, from which content associated with the service can be provided; and the selection is made based on an edge server location that is closest to the location of the mobile device identified by the information.

Example Clause P, the system of Example Clause N, wherein the action comprises preventing the service from completing a location-based operation based at least in part on the location of the mobile device violating a geographic restriction associated with the location-based operation.

Example Clause Q, the system of Example Clause P, wherein the location-based operation comprises a transaction; and the other location determined based on the IP address complies with the geographic restriction.

Example Clause R, the system of any one of Example Clauses N through Q, wherein the operations further comprise: receiving, from the mobile network operator, a uniform resource locator configured to obtain user consent for determining the location of the mobile device identified by the information; providing the uniform resource locator to the device from which the request is received; receiving, by way of the uniform resource locator, the user consent; and providing an indication of the user consent to the mobile network operator.

Example Clause S, the system of any one of Example Clauses N through Q, wherein the operations further comprise: requesting user consent for determining the location of the mobile device identified by the information in association with terms of use for the service during a setup of the user account; receiving, by way of the terms of use, the user consent; and providing an indication of the user consent to the mobile network operator.

Example Clause T, the system of any one of Example Clauses N through S, wherein: the information that identifies the mobile device comprises a phone number; and the phone number and the mobile device are subscribed to a mobile network operated by the mobile network operator.

Although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Conditional language used herein, such as, among others, "can," "could," "might," "may," "e.g.," and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms "comprising," "including," "having," and the like are synonymous and are used inclusively, in an open-ended fashion, and do not exclude additional elements, features, acts, operations, and so forth. Also, the term "or" is used in its inclusive sense (and not in its exclusive sense) so that when used, for example, to connect a list of elements, the term "or" means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated any reference to “first,” “second,” etc. items and/or abstract concepts within the description is not intended to and should not be construed to necessarily correspond to any reference of “first,” “second,” etc. elements of the claims. In particular, within this Summary and/or the following Detailed Description, items and/or abstract concepts such as, for example, individual computing devices and/or operational states of the computing cluster may be distinguished by numerical designations without such designations corresponding to the claims or even other paragraphs of the Summary and/or Detailed Description.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for verifying a location of a device via use of a mobile network, the method comprising:
receiving, from the device, a request to access a service hosted via a cloud platform, wherein the request identifies a user account and the request is associated with an Internet Protocol (IP) address;
associating the request with information, registered for or in the user account, that identifies a mobile device;
sending a query, to a mobile network operator, asking for a location of the mobile device identified by the information;
receiving, from the mobile network operator, the location of the mobile device identified by the information; and
implementing an action based on the location of the mobile device identified by the information rather than another location determined based on the IP address, wherein:
the action comprises selecting an edge server, amongst multiple available edge servers, from which content associated with the service can be provided; and
the selection is made based on an edge server location that is closest to the location of the mobile device identified by the information.

2. The method of claim 1, wherein:
the information that identifies the mobile device comprises a phone number; and
the phone number and the mobile device are subscribed to a mobile network operated by the mobile network operator.

3. The method of claim 1, wherein the content includes at least one of streaming content, gaming content, or videoconference content.

4. The method of claim 1, further comprising:
receiving, from the mobile network operator, a uniform resource locator configured to obtain user consent for determining the location of the mobile device identified by the information;
providing the uniform resource locator to the device from which the request is received;
receiving, by way of the uniform resource locator, the user consent; and
providing an indication of the user consent to the mobile network operator.

5. The method of claim 1, further comprising:
requesting user consent for determining the location of the mobile device identified by the information in association with terms of use for the service during a setup of the user account;
receiving, by way of the terms of use, the user consent; and
providing an indication of the user consent to the mobile network operator.

6. The method of claim 1, wherein the mobile device and the device from which the request is received are different devices.

7. The method of claim 1, wherein the mobile device and the device from which the request is received are a same device.

8. The method of claim 1, wherein the mobile network operator uses cell tower triangulation to determine the location of the mobile device.

9. A method for verifying a location of a device via use of a mobile network, the method comprising:
receiving, from the device, a request to access a service hosted via a cloud platform, wherein the request identifies a user account and the request is associated with an Internet Protocol (IP) address;
associating the request with information, registered for or in the user account, that identifies a mobile device;
sending a query, to a mobile network operator, asking for a location of the mobile device identified by the information;
receiving, from the mobile network operator, the location of the mobile device identified by the information; and
implementing an action based on the location of the mobile device identified by the information rather than another location determined based on the IP address, wherein the action comprises preventing the service from completing a location-based operation based at least in part on the location of the mobile device violating a geographic restriction associated with the location-based operation.

10. The method of claim 9, wherein:
the location-based operation comprises a transaction; and
the other location determined based on the IP address complies with the geographic restriction.

11. The method of claim 9, wherein:
the information that identifies the mobile device comprises a phone number; and
the phone number and the mobile device are subscribed to a mobile network operated by the mobile network operator.

12. The method of claim 9, further comprising:
receiving, from the mobile network operator, a uniform resource locator configured to obtain user consent for determining the location of the mobile device identified by the information;
providing the uniform resource locator to the device from which the request is received;
receiving, by way of the uniform resource locator, the user consent; and
providing an indication of the user consent to the mobile network operator.

13. The method of claim 9, further comprising:
requesting user consent for determining the location of the mobile device identified by the information in association with terms of use for the service during a setup of the user account;
receiving, by way of the terms of use, the user consent; and
providing an indication of the user consent to the mobile network operator.

14. A system comprising:
one or more processers; and
computer storage media storing instructions that, when executed by the one or more processors, cause the system to perform operations comprising:
receiving, from a device, a request to access a service hosted via a cloud platform, wherein the request identifies a user account and the request is associated with an Internet Protocol (IP) address;
associating the request with information, registered for or in the user account, that identifies a mobile device;
sending a query, to a mobile network operator, asking for a location of the mobile device identified by the information;
receiving, from the mobile network operator, the location of the mobile device identified by the information; and
implementing an action based on the location of the mobile device identified by the information rather than another location determined based on the IP address.

15. The system of claim 14, wherein:
the action comprises selecting an edge server, amongst multiple available edge servers, from which content associated with the service can be provided; and
the selection is made based on an edge server location that is closest to the location of the mobile device identified by the information.

16. The system of claim 14, wherein the action comprises preventing the service from completing a location-based operation based at least in part on the location of the mobile device violating a geographic restriction associated with the location-based operation.

17. The system of claim 16, wherein:
the location-based operation comprises a transaction; and
the other location determined based on the IP address complies with the geographic restriction.

18. The system of claim 14, wherein the operations further comprise:
receiving, from the mobile network operator, a uniform resource locator configured to obtain user consent for determining the location of the mobile device identified by the information;
providing the uniform resource locator to the device from which the request is received;
receiving, by way of the uniform resource locator, the user consent; and
providing an indication of the user consent to the mobile network operator.

19. The system of claim 14, wherein the operations further comprise:
requesting user consent for determining the location of the mobile device identified by the information in association with terms of use for the service during a setup of the user account;
receiving, by way of the terms of use, the user consent; and
providing an indication of the user consent to the mobile network operator.

20. The system of claim 14, wherein:
the information that identifies the mobile device comprises a phone number; and
the phone number and the mobile device are subscribed to a mobile network operated by the mobile network operator.
